(19) United States
(12) Patent Application Publication
(10) Pub. No.: US 2008/0250923 A1
(43) Pub. Date: Oct. 16, 2008

(54) Piston and process for manufacturing the same

(75) Inventors: Kenichi Mitsui, Aichi-ken (JP); Tatsuo Suzuki, Aichi-ken (JP); Tadanobu Ota, Aichi-ken (JP); Takao Suzuki, Aichi-ken (JP); Hiroshi Onaka, Aichi-ken (JP); Yasunori Uchida, Aichi-ken (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-ken (JP); TOYOTA JIDOSHA KABUSHIKI KAISHA, Aichi-ken (JP)

(21) Appl. No.: 12/078,200

(22) Filed: Mar. 27, 2008

(30) Foreign Application Priority Data
Mar. 29, 2007 (JP) 2007-088743
Mar. 26, 2008 (JP) 2008-080619

(51) Int. Cl. F16J 9/00

(52) U.S. Cl. 92/248; 29/888.04

(57) ABSTRACT

A piston includes a piston body, an elastic adhesive layer, and a low thermal-conductivity sheet. The piston body has a piston top surface facing a combustion chamber, and exhibits a first thermal conductivity. The elastic adhesive sheet is formed on the piston top surface of the piston body, and includes a heat resistant resin. The low thermal-conductivity sheet is formed on the elastic adhesive layer, and exhibits a second thermal conductivity being lower than the first thermal conductivity of the piston body and falling in a range of from 5 or more to 40 W/m·K or less.

The present invention is based on Japanese Patent Application No. 2007-88,743, filed on Mar. 29, 2007, and on Japanese Patent Application No. 2008-80,619, filed on Mar. 26, 2008, the entire contents of which are incorporated herein by reference.

### BACKGROUND OF THE INVENTION

1. Field of the Invention

The present invention relates to a piston. In particular, it relates to a piston, which is provided with an improved construction of the top surface that faces a combustion chamber of internal combustion engine.

2. Description of the Related Art

When starting internal combustion engine, such as an automobile engine, or when running it at low load, if a top surface of piston, which faces a combustion chamber, exhibits a low temperature, a gaseous fuel within the combustion chamber might turn into liquid to adhere onto the top surface of piston so that it has resulted in unburned gases. If such is the case, the unburned gases might bring about the emission of hydrocarbons, and the deterioration of mileage (or fuel economy).

On the contrary, when running internal combustion engine at high load during which it exhibits a high engine temperature, if the top surface of piston exhibits an excessively high temperature, the degradation of engine oil is likely to develop, and moreover knocking is likely to occur because an air-fuel mixture within the combustion chamber has been overheated. In addition, the air volume inside the combustion chamber has decreased to result in a fear of lowering the output of internal combustion engine.

In view of above, Japanese Unexamined Patent Publication (KOKAI) Gazette No. 8-100,659 discloses a piston with a low thermal-diffusivity paint film formed. The low thermal-diffusivity paint film is formed on the piston's top surface that faces a combustion chamber, and exhibits a low thermal diffusivity. Moreover, the low thermal-diffusivity paint film is formed on the piston's top surface by means of plasma spraying. In plasma spraying, a powdery paint-film material, such as titanium aluminide, zirconium oxide and stainless steel, is injected into plasma, and is then applied to a workpiece.

In the conventional piston, the low thermal-diffusivity paint film, which is formed on the piston's top surface, can inhibit heat, which has been stored, for instance, in the piston, from being emitted to an air-fuel mixture within the combustion chamber. Accordingly, at high load during which internal combustion engine exhibits a high engine temperature, the conventional piston can suppress the degradation of engine oil, or can inhibit the air-fuel mixture within the combustion chamber from overheating and can thereby prevent the occurrence of knocking or can thereby keep the output of internal combustion engine from lowering.

Moreover, Japanese Unexamined Patent Publication (KOKAI) Gazette No. 1-170,745 discloses another conventional piston. This second conventional piston is provided with a dent, which is formed in the top surface. In addition, the dent has a three-layered construction that comprises a superficial layer, a heat-insulation elastic layer, and a metallic cast substance. The superficial layer is made of a ceramic sintered substance. The heat-insulation elastic layer surrounds the superficial layer's outer peripheral surface, and is made of a nonmetallic inorganic porous substance, such as a porous ceramic molded body or a ceramic fiber molded body. The metallic cast substance is cast around the heat-insulation elastic layer, thereby forming the second conventional piston's main body.

However, in the first conventional piston disclosed in Japanese Unexamined Patent Publication (KOKAI) Gazette No. 8-100,659, there might be such a fear that the low thermal-diffusivity paint film, which is formed on the piston's top surface has been damaged or has been come off because of the difference between the thermal expansion coefficient of the low thermal-diffusivity paint film, which comprises titanium nitride or zirconium oxide, and that of the piston's base material.

Moreover, the first conventional piston, which is provided with the low thermal-diffusivity paint film being formed by means of plasma spraying, might have suffered from the difficulty in view of manufacturing, because it is necessary to employ a plasma generator, or because it is troublesome to set specific conditions for forming a paint film with a predetermined desirable thickness.

In the meanwhile, it is troublesome to manufacture the second conventional piston disclosed in Japanese Unexamined Patent Publication (KOKAI) Gazette No. 1-170,745, because it is required to cast the metallic cast substance around the heat-insulation elastic layer when casting the piston body. Moreover, the second conventional piston might demonstrate insufficient reliability regarding the bondability of the superficial layer and heat-insulation elastic layer to the piston body.

### SUMMARY OF THE INVENTION

The present invention has been developed in view of the aforementioned circumstances. It is therefore an object of the present invention to provide a piston, which can not only inhibit its top surface from exhibiting an excessively low temperature when its own temperature is low, thereby suppressing fuel from condensing or liquefying, and which can but also inhibit its top surface from exhibiting a superfluously high temperature when its own temperature is high, thereby suppressing the degradation of engine oil, the occurrence of knocking and the lowering of internal combustion engine's output. Moreover, it is a further object of the present invention to provide a piston, which comprises a constituent element, a low thermal-conductivity sheet, that not only enables the piston to perform the aforementioned functions but also is hardly damaged or come off because of the difference between thermal expansion coefficients. In addition, it is a furthermore object of the present invention to provide such a piton, which can be manufactured with case.

Moreover, it is another object of the present invention to provide such a low thermal-conductivity sheet, which shows improved reliability regarding the bondability to piston body.

A piston according to the present invention comprises:

a piston body having a piston top surface facing a combustion chamber, and exhibiting a first thermal conductivity;

an elastic adhesive layer being formed on the piston top surface of the piston body, and comprising a heat resistant resin; and

a low thermal-conductivity sheet being formed on the elastic adhesive layer, and exhibiting a second thermal conductivity being lower than the first thermal conductivity of the piston body and falling in a range of from 5 or more to 40 W/m·K or less.

The present piton comprises the low thermal-conductivity sheet. The low thermal-conductivity sheet is bonded to the piston top surface of the piton body, which faces a combustion chamber, by way of the elastic adhesive layer. The low thermal-conductivity sheet exhibits a second thermal conductivity of 40 W/m·K or less, thereby functioning as a heat insulation layer. Accordingly, when starting engine, that is, upon cold starting engine when the temperature within combustion chamber and that of piston are low, or when running engine at low load, it is possible to suppress the heat conduction from the low thermal-conductivity sheet, whose temperature is increased by the heat emitted from the combustion chamber, to the piston body, and thereby it is possible to quickly increase the temperature of a part in the piston top surface, part above which the low thermal-conductivity sheet is disposed. Consequently, when starting engine or when running it at low load, the present piston can prevent such a drawback that fuel within the combustion chamber has turned into liquefied fuel and then has adhered onto the piston top surface to eventually become unburned gases because the temperature of the piston top surface is low excessively. Therefore, the present piston can keep the emission of hydrocarbons and the deterioration of mileage (or fuel economy) from occurring.

On the other hand, the low thermal-conductivity sheet exhibits the second thermal conductivity of 5 W/m·K or more. Accordingly, even when the low thermal-conductivity sheet is heated, the low thermal-conductivity sheet hardly shows a superfluously high temperature because it can appropriately radiate or dissipate heat to the piston body by way of the elastic adhesive layer. Therefore, when running engine at high load, the low thermal-conductivity sheet enables the present piston to suppress the degradation of engine oil, the occurrence of knocking and the lowering of engine's output.

Moreover, the present piston comprises the elastic adhesive layer. The elastic adhesive layer bonds the low thermal-conductivity sheet to the piston top surface of the piston body, and intervenes between the low thermal-conductivity and the piston body. The elastic adhesive layer undergoes elastic deformation, thereby absorbing the relative thermal deformations between the low thermal-conductivity sheet and the piston body that result from the difference between their thermal expansion coefficients. As a result, even when the low thermal-conductivity sheet undergoes relative deformation to the piston body because of the difference between their thermal expansion coefficients, the elastic adhesive layer can inhibit the low thermal-conductivity sheet from breaking down or coming off from the piston body.

In addition, the present piston can be manufactured by means of such an extremely simple method as bonding a sheet-shaped low thermal-conductivity sheet to the piston top surface of the piston body with an adhesive agent.

In the present piston, the piston body can preferably have a dent being disposed in the piston top surface and having a bottom surface, and a protrusion being disposed on the bottom surface of the dent and having a leading-end surface; the protrusion can preferably have an outer peripheral surface, and a dented engager being disposed in the outer peripheral surface; the elastic adhesive layer can preferably have a leading-end surface being formed on the leading-end surface of the protrusion, and a peripheral surface being formed on the outer peripheral surface of the protrusion; and the low thermal-conductivity sheet can preferably be formed as a bottomed cylindrical configuration, the bottomed cylindrical configuration having a leading-end-surface covering portion for covering the leading-end surface of the elastic adhesive layer and a peripheral-surface covering portion for covering the peripheral surface of the elastic adhesive layer.

In the first preferable present piston being constructed as described above, not only the elastic adhesive layer's leading end surface is covered with the low thermal-conductivity sheet's leading-end-surface covering portion but also the elastic adhesive layer's peripheral surface is covered with the low thermal-conductivity sheet's peripheral-surface covering portion. Accordingly, it is possible to satisfactorily inhibit the elastic adhesive layer from being exposed to the combustion chamber. Consequently, the first preferable present piston can satisfactorily prevent the elastic adhesive layer from being degraded by heat within the combustion chamber, or can satisfactorily prevent the elastic adhesive layer from being burned to be carbonized eventually by fires combusting within the combustion chamber.

In the above-described first preferable present invention, the elastic adhesive layer can preferably include a protruded engager, which engages with the dented engager of the protrusion of the piston body.

The second preferable present piston being this constructed can satisfactorily inhibit the elastic adhesive layer from coming off from the piston body, because the protruded engager of the elastic adhesive layer engages with the dented engager of the piston body's protrusion mechanically.

In the above-described first preferable present piston, the low thermal-conductivity sheet can preferably further have a bent engager, being made by bending the peripheral-surface covering portion inwardly at around a free end thereof, and engaging with the dented engager of the protrusion.

In the third preferable present piston being thus constructed, the low thermal-conductivity sheet's bent engager engages with the dented engager of the piston body's protrusion mechanically. As a result, the resulting mechanical engaging force makes it possible to satisfactorily inhibit the low thermal-conductivity sheet from coming off from the piston body.

Moreover, it is possible to mechanically engage the piston body with the low thermal-conductivity sheet by means of such a simple method as, after bonding the low thermal-conductivity sheet onto the bottom surface of the piston body's dent with the elastic adhesive layer, simply crimping a part of the low thermal-conductivity sheet, which turns into the bent engager, inwardly at around a free end thereof and then engaging it with the dented engager of the piston body's protrusion.

In the above-described first preferable present piston, the elastic adhesive layer can preferably intervene between the piston body and the low thermal-conductivity sheet to separate the piston body and the low thermal-conductivity sheet away from each other.

In the fourth preferable present piston being thus constructed, the presence of the elastic adhesive sheet, which intervenes between the piston body and the low thermal-conductivity sheet, makes the piston body and the low thermal-conductivity sheet separate away from each other so that they are put in a noncontact state. Accordingly, it is possible to prevent the heat conduction from the low thermal-conductivity sheet to the piston body upon starting engine, for instance. Consequently, it becomes feasible to let the low thermal-conductivity sheet undergo temperature increment quickly.

In the present piston, the piston body can preferably further have a dent being disposed in the piston top surface, and being provided with a bottom surface and an inner peripheral surface; the elastic adhesive layer can preferably be formed on the bottom surface of the dent of the piston body; and one of the piston body and the low thermal-conductivity sheet can preferably have an engager engaging with another one of the piston body and the low thermal-conductivity sheet.

In the fifth preferable present piston being thus constructed, the piston body and the low thermal-conductivity sheet engage with each other by the engager, with which one of the piston body and the low thermal-conductivity sheet is provided, thereby producing a mechanical engaging force between them. Thus, the resulting mechanical engaging force makes it possible to inhibit the low thermal-conductivity sheet from coming off from the piston body.

In the above-described fifth preferable present piston, the engager can preferably comprise a crimped portion being formed by means of crimping process.

In the sixth preferable present piston being thus constructed, it is possible to mechanically engage the piston body with the low thermal-conductivity sheet by means of such a simple method as, after bonding the low thermal-conductivity sheet onto the bottom surface of the piston body's dent with the elastic adhesive layer, simply crimping one of the piston body and the low thermal-conductivity sheet to provide the one of them with the engager, which makes the one of them engageable with the other one of them.

In the above-described fifth preferable present piston, the piston body can preferably have a dented engager being disposed in the inner peripheral surface of the dent; and the low thermal-conductivity sheet can preferably have an outer peripheral end, and a protruding engager protruding outward from the outer peripheral end and engaging with the dented engager.

In the seventh preferable present piston being thus constructed, it is possible to mechanically engage the piston body with the low thermal-conductivity sheet by means of such a simple method as engaging the low thermal-conductivity sheet's protruding engager with the piston body's dented engager while bonding the low thermal-conductivity sheet onto the bottom surface of the piston body's dent with the elastic adhesive layer.

In the present piston, the piston body or the low thermal-conductivity sheet can preferably have a cavity for making a hollow between the piston body or the low thermal-conductivity sheet and the elastic adhesive layer.

In the eighth preferable present piston being thus constructed, the hollow, which is disposed between the piston body or the low-thermal conductivity sheet and the elastic adhesive layer, functions as an air heat-insulation layer. Accordingly, when starting engine or running it at low load, it is possible to quickly increase the temperature of the low-thermal conductivity sheet, of the parts of the piston body's piston top surface above which the low thermal-conductivity sheet is disposed.

In the present piston, the low thermal-conductivity sheet can preferably comprise at least one member being selected from the group consisting of titanium, titanium alloys and stainless steels.

In the present piston, the elastic adhesive layer can preferably exhibit a third thermal conductivity, which is lower than the second thermal conductivity of the low thermal-conductivity sheet.

In the above-described tenth preferable present piston, the low elastic adhesive layer can preferably comprise at least one member being selected from the group consisting of polyimide, denatured polyimide, polybenzimidazole and denatured polybenzimidazole.

In the present piston, the low thermal-conductivity sheet can preferably exhibit a thickness of from 0.1 to 0.5 mm.

In the present invention, the elastic adhesive layer can preferably exhibit a thickness of from 0.01 to 1.0 mm.

A process according to the present invention is for manufacturing piston, the piston comprising: a piston body having a piston top surface facing a combustion chamber, and exhibiting a first thermal conductivity; an elastic adhesive layer being formed on the piston top surface of the piston body, and comprising a heat resistant resin; and a low thermal-conductivity sheet being formed on the elastic adhesive layer, and exhibiting a second thermal conductivity being lower than the first thermal conductivity of the piston body and falling in a range of from 5 or more to 40 W/m K or less;

the piston manufacturing process comprises the steps of;

applying an elastic adhesive agent containing an organic solvent onto the piston body;

prebaking the elastic adhesive agent by heating the elastic adhesive agent to a predetermined temperature, thereby evaporating the organic solvent;

disposing the low thermal-conductivity sheet onto the prebaked elastic adhesive agent; and

bonding the piston body with the low thermal-conductivity sheet by further heating the prebaked elastic adhesive agent to polymerize and cure it, thereby turning the prebaked elastic adhesive agent into the elastic adhesive layer, which bonds the piston body with the low thermal-conductivity sheet.

The piston manufacturing process according to the present invention makes it possible to manufacture the present piston by such a series of simple techniques, such as applying an elastic adhesive agent, prebaking the elastic adhesive agent, disposing the low thermal-conductivity sheet and heating the elastic adhesive agent to cure it.

All in all, the present piston can inhibit the low thermal-conductivity sheet from being damaged or being come off because of the difference between the thermal expansion coefficients of the piston body and low thermal-conductivity sheet. Moreover, it is possible to manufacture the present piston by means of such an extremely simple method as bonding a sheet-shaped low thermal-conductivity sheet to a piston body's top surface with an adhesive agent, and then crimping the piston body or the low thermal-conductivity sheet at least, if necessary.

In addition, when the present piston comprises the piston body and low thermal-conductivity sheet that engage mechanically with each other, the present piston can demonstrate improved reliability regarding the bondability of the low thermal-conductivity sheet to the piston body.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a cross-sectional diagram for illustrating a construction of a piston according to Example No. 1 of the present invention.

FIG. 2 is cross-sectional diagrams for illustrating a series of steps for manufacturing the present piston according to Example No. 1; wherein FIG. 2 (a) shows a piston body being molded by means of casting; FIG. 2 (b) shows such a state that a liquid monomer, a polyimide precursor, is applied on the piston body's dent; FIG. 2 (c) shows such a state that a low thermal-conductivity sheet comprising titanium is bonded onto the dent by means of curing the liquid monomer, a polyimide precursor, by heating; and FIG. 2 (d) shows such a state that the dent's peripheral end opening is crimped, thereby forming an annular protrusion.

FIG. 3 is a cross-sectional diagram for illustrating a construction of a piston according to Example No. 2 of the present invention.

FIG. 4 is a perspective diagram for illustrating a low thermal-conductivity sheet, one of the constituent elements of the present piston according to Example No. 2.

FIG. 5 is a cross-sectional diagram for illustrating a construction of a piston according to Example No. 3 of the present invention.

FIG. 6 is cross-sectional diagrams for illustrating a series of steps for manufacturing the present piston according to Example No. 3; wherein FIG. 6 (a) shows a piston body being molded by means of casting; and FIG. 6 (b) shows such a state that a liquid monomer, a polyimide precursor, is applied on a protrusion of the piston body's dent before covering the protrusion with a low thermal-conductivity sheet.

FIG. 7 is a cross-sectional diagram for illustrating a construction of a piston according to Example No. 4 of the present invention.

FIG. 8 is a perspective diagram for illustrating a low thermal-conductivity sheet, one of the constituent elements of the present piston according to Example No. 4, in such a state prior to forming a bent engager by means of bending.

FIG. 9 is a cross-sectional diagram for illustrating a construction of a piston according to Example No. 5 of the present invention.

FIG. 10 is a cross-sectional diagram for illustrating a construction of a piston according to Example No. 6 of the present invention.

FIG. 11 is a cross-sectional diagram for illustrating a construction of a piston according to Example No. 7 of the present invention.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### EXAMPLES

Specific examples of a piston according to the present invention will be hereinafter described in more detail with reference to the drawings.

### Example No. 1

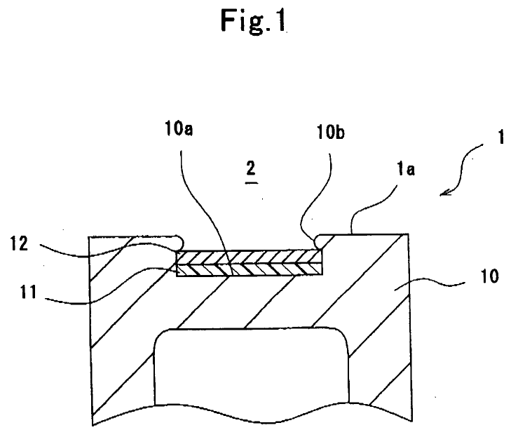

FIG. 1 illustrates a piston 1 for internal combustion engine according to Example No. 1 of the present invention in a cross-sectional view. As shown in FIG. 1, the present piston 1 according to Example No. 1 is disposed reciprocally within an engine's cylinder (not shown) to use. In particular, the present piston according to Example No. 1 is used for a direct-injection engine that injects fuel directly into a combustion chamber 2, which the cylinder and the present piston's top surface 1a demarcate.

The present piston 1 according to Example No. 1 comprises a piston body 10, an elastic adhesive layer 11, and a low thermal-conductivity sheet 12. The piston body 10 has the piston top surface 1a, which faces the combustion chamber 2. The elastic adhesive layer 11 is disposed on the piston top surface 1a. The low thermal-conductivity 12 is formed as a thin plate shape, and is disposed on the elastic adhesive layer 11.

The piston body 10 comprises an aluminum alloy, and is molded as a predetermined configuration by means of casting. The piston body 10 has a dent 10a. The dent 10a is disposed in a central part of the piston body 10's piston top surface 1a, and is dented as an indented shape. Moreover, the elastic adhesive layer 11 and low thermal-conductivity sheet 12 are placed within the dent 10a.

The piston body 10's dent 10a has a bottom-surface configuration, which meets the low thermal-conductivity sheet 12's outer configuration substantially. Note that the configuration of the dent 10a is not limited in particular as far as the elastic adhesive layer 11 and low thermal-conductivity sheet 12 can be placed on the bottom surface of the dent 10a. In the present piston 1 according to Example No. 1, since the low thermal-conductivity sheet 12 comprises a thin disk-shaped metallic sheet, the dent 10a's bottom-surface configuration is formed as a circular shape whose diameter is equal to that of the disk-shaped low thermal-conductivity sheet 12 substantially. Moreover, the dent 10a has a depth, which is greater than a summed thickness of the elastic adhesive layer 11 and low thermal-conductivity sheet 12.

The elastic adhesive layer 11, which is disposed on the entire bottom surface of the dent 10a, bonds the low thermal-conductivity sheet 12 onto the bottom surface of the dent 10a. Moreover, the dent 10a's peripheral-end opening is provided with an annular protrusion 10b, which protrudes centripetally. The annular protrusion 10b contacts with an outer peripheral surface of the low thermal-conductivity sheet 12 (or the low thermal-conductivity sheet 12's top surface specifically), thereby engaging the piston body 10 with the low thermal-conductivity sheet 12. The annular protrusion 10b functions as the claimed engager, and comprises a crimped portion being formed by means of crimping process. Specifically, the annular protrusion 10b is formed by means of deforming the entire periphery of the dent 10b's peripheral-end opening plastically by crimping it centripetally after bonding the low thermal-conductivity sheet 12 onto the dent 10a's bottom surface. Note that, instead of the annular protrusion 10b, it is allowable to form a plurality of protrusions by crimping the dent 10b's peripheral-end opening at a plurality of locations, which are disposed at predetermined intervals peripherally.

The piston body 10's configuration, such as the piston top surface 1a, is not limited in particular, and can be determined appropriately. Moreover, a material that makes the piston body 10 is not limited in particular, either.

The elastic adhesive layer 11 comprises a heat-resistant resin. As for the heat-resistant resin making the elastic adhesive layer, it is not limited in particular as far as it does not melt or decompose but demonstrates predetermined adhesion force and elastic force while the present piston 1 according to Example No. 1 is put into operation. Specifically, it is possible to use such a heat-resistant resin for making the elastic adhesive layer 11, heat-resistant resin which demonstrates predetermined adhesion force during the present piston 1's operation so that it can securely bond the low thermal-conductivity sheet 12 on the dent 10's bottom surface; and heat-resistant resin which demonstrates predetermined elastic force when the present piston 1 operates so that it can absorb relative thermal deformations of the piston body 10 and low thermal-conductivity sheet 12 that result from the difference between their thermal expansion coefficients.

Moreover, the elastic adhesive layer 11 can preferably exhibit a thickness of from 0.01 to 1.0 mm, more preferably from 0.3 to 0.7 mm. When the elastic adhesive layer 11 is too thin, it might not be able to effectively absorb relative thermal deformations of the piston body 10 and low thermal-conductivity sheet 12 that result from the thermal-expansion-coefficient difference between them. On the other hand, when the elastic adhesive layer 11 is too thick, the resulting elastic adhesive layer 11 becomes likely to crack.

As for the heat-resistant resin for making the elastic adhesive layer, it is possible to suitably use polyimide, which exhibits one of the best heat resistances among synthetic resins, or denatured polyimide, for instance. Although polyimide or denatured polyimide can be either thermoplastic or thermosetting, thermosetting polyimide is d preferable option in view of securely providing the elastic adhesive layer 11 with required heat resistance. As for another preferable option for the heat-resistant resin for making the elastic adhesive layer 11, it is possible to name polybenzimidazole (PBI) or denatured polybenzimidazole.

Moreover, the elastic adhesive layer 11 can preferably exhibit a third thermal conductivity, which is lower than the second thermal conductivity of the low thermal-conductivity sheet 12. For example, the third thermal conductivity of the elastic adhesive layer 11 can preferably be 5 W/m·K or less, more preferably from 1 W/m·K or less. When the third thermal conductivity of the elastic adhesive layer 11 is too high, heat becomes likely to move from the low thermal-conductivity sheet 12 to the piston body 10 by way of the elastic adhesive sheet 11 upon starting engine, for instance, thereby keeping the piston top surface 1a from exhibiting quick temperature increment.

The low thermal-conductivity sheet 12 comprises a material, which exhibits a second thermal conductivity that is lower than the first thermal conductivity of the material that makes the piston body 10; and which does not melt or decompose during the operation of the present piston 1 according to Example No. 1. The low thermal-conductivity sheet 12 exhibits a second thermal conductivity of from 5 or more to 40 W/m·K or less. When the second thermal conductivity of the low thermal-conductivity sheet 12 is less than 5 W/m·K, the resulting low thermal-conductivity sheet 12 becomes less likely to radiate or dissipate heat upon running engine at high load so that the degradation of engine oil and the knocking phenomena are likely to occur. On the other hand, when the second thermal conductivity of the low thermal-conductivity sheet 12 is more than 40 W/m·K, the resultant low thermal-conductivity sheet 12 becomes likely to radiate or dissipate heat so that unburned gases are likely to generate.

Although the material for making the low thermal-conductivity sheet 12 can be either metal or ceramic, it can preferably be a metal such as titanium, titanium alloys or stainless steels (e.g., SUS as per Japanese Industrial Standard) from the viewpoint of making piston lightweight and turning it into being highly tough. Moreover, among the metals, titanium or titanium alloys are preferable options because they exhibit a lower thermal conductivity and a smaller specific gravity.

The low thermal-conductivity sheet 12 can preferably exhibit a thickness of from 0.1 to 0.5 mm. When the low thermal-conductivity sheet 12 is too thin, it cannot demonstrate the functions as a heat insulation layer effectively. On the other hand, when the low thermal-conductivity sheet 12 is too thick, it heightens the height of piston itself and makes the weight heavier so that the resulting piston might come to adversely affect the mileage (or fuel economy) of vehicle.

For example, in the present piston according to Example No. 1, the low thermal-conductivity sheet 12 comprised a titanium sheet whose thickness was 0.3 mm, and the resultant low thermal-conductivity sheet 12 exhibited a second thermal conductivity of 21.9 W/m·K. Moreover, the elastic adhesive layer 11 comprised a thermosetting polyimide. In addition, the resulting elastic adhesive layer 11 had a thickness of 0.05 mm, and exhibited a third thermal conductivity of 0.2 W/m·K.

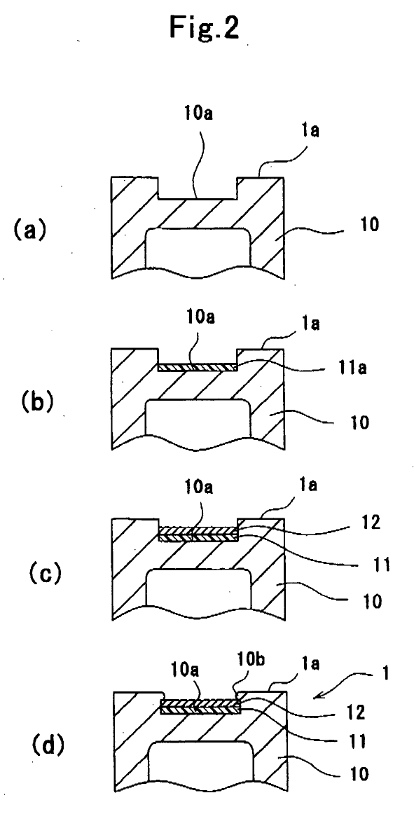

The thus constructed present piston 1 according to Example No. 1 can be manufactured as hereinafter described and as illustrated in FIG. 2, for instance.

Specifically, as shown in FIG. 2(a), the piston body 10, which has a predetermined configuration, is molded first by means of casting. Then, as shown in FIG. 2 (b), a liquid monomer 11a, a polyimide precursor, is applied on the bottom surface of the dent 10a, which is formed in the piston top surface 1a, in a predetermined thickness; and the liquid monomer 11a is pre-baked at a temperature of 150° C. or more to evaporate an organic solvent containing therein before placing the low thermal-conductivity sheet 12, which has a predetermined configuration, thereon. Thereafter, the liquid monomer 11a, a polyimide precursor, is polymerized to cure by heating it to such a high temperature as 200° C. or more, thereby turning it into the elastic adhesive layer 11. Thus, as shown in FIG. 2 (c), the elastic adhesive layer 11 bonds the low thermal-conductivity sheet 12 onto the bottom surface of the piston body 10's dent 10a. Finally, as shown in FIG. 2 (d), the peripheral-end opening of the dent 10a is crimped to form the annular protrusion 10b.

The present piston 1 according to Example No. 1 comprises the low thermal-conductivity sheet 12 and elastic adhesive layer 11 that are provided on the piston top surface 1a, which faces the combustion chamber 2, for functioning as a heat insulation layer. Accordingly, upon starting engine or operating it at low load during which the temperature of piston is low, the present piston 1 according to Example No. 1 can quickly increase the temperature of the low thermal-conductivity sheet 12 of the parts of the piston top surface 1a, and can thereby inhibit the fuel inside the combustion chamber 2 from turning into unburned gases. Consequently, the low thermal-conductivity sheet 12 and elastic adhesive layer 11 enable the present piston 1 according to Example No. 1 to prevent hydrocarbons from being emitted and the mileage (or fuel economy) of vehicle from deteriorating.

On the other hand, when running engine at high load during which the temperature of piston rises, the low thermal-conductivity sheet 2 hardly exhibits excessively high temperature, because it can radiate or dissipate heat appropriately. Therefore, the present piston 1 according to Example No. 1 makes it possible to suppress the degradation of engine oil and the occurrence of knocking.

Moreover, the present piston 1 according to Example No. 1 comprises the elastic adhesive layer 11, which intervenes between the low thermal-conductivity sheet 12 and the piston body 10. The low thermal-conductivity sheet 12, which is interposed between the low thermal-conductivity sheet 12 and the piston body 10 undergoes elastic deformations to absorb the relative thermal deformations between the low thermal-conductivity sheet 12 and the piston body 10. As a result, even when the low thermal-conductivity sheet 12 undergoes relative deformations to the piston body 10 because of the difference between their thermal expansion coefficients, the elastic adhesive layer 11 makes it possible to keep the low thermal-conductivity sheet 12 from breaking, and to keep the low thermal-conductivity sheet 12 from coming off from the piston body 10.

In addition, it is possible to manufacture the present piston 1 according to Example No. 1 by means of such an extremely simple method as bonding the sheet-shaped low thermal-conductivity sheet 12 onto the piston body 10 using an adhesive agent.

Moreover, in the present piston 1 according to Example No. 1, the low thermal-conductivity sheet 12, which functions as a heat insulation layer, comprises a titanium sheet. When being compared with the case where a heat insulation layer is formed by means of paint film, not only the present piston 1 according to Example No. 1 is advantageous for securing the durability of the low thermal-conductivity sheet 12, but also it makes easier to give the low thermal-conductivity sheet 12 a uniform thickness. Moreover, among metals, titanium exhibits an especially low thermal conductivity, and shows a small specific gravity as well. Therefore, not only the low thermal-conductivity sheet 12 demonstrates a heat insulation effect usefully, but also it can keep the weight increment of the present piston 1, which results from providing the low thermal-conductivity sheet 12 on the piston top surface 1a, minimum.

In addition, in the present piston 1 according to Example No. 1, the elastic adhesive layer 11's third thermal conductivity is controlled so that it is lower than the low thermal-conductivity sheet 12's second thermal conductivity considerably. Accordingly, the elastic adhesive layer 11 produces a heat insulation effect considerably greater than the low thermal-conductivity sheet 12 produces a heat insulation effect. Since the elastic adhesive layer 11, which produces such a greater heat insulation effect, intervenes between the low thermal-conductivity sheet 12 and the piston body 10, the present piston 1 according to Example No. 1 can inhibit the heat transfer from the low thermal-conductivity sheet 12 to the piston body 10 with the elastic adhesive layer 11 effectively. Consequently, upon starting engine, the present piston 1 according to Example No. 1 can increase the low thermal-conductivity sheet 12's temperature more quickly, thereby making it possible to prevent the occurrence of unburned gases more beneficially.

What is more, in the present piston 1 according to Example No. 1, since the annular protrusion 10b of the piston body 10 engages with the outer periphery of the low thermal-conductivity sheet 12, the resulting mechanical engaging force makes it possible to keep the low thermal-conductivity sheet 12 from coming off from the piston body 10.

Moreover, in the present piston 1 according to Example No. 1, since the low thermal-conductivity sheet 12 covers the elastic adhesive sheet 11 completely, not only the low thermal-conductivity sheet 12 can satisfactorily keep the elastic adhesive sheet 11 from degrading because of the heat inside the combustion chamber 2, but also it can securely inhibit fires, which combust within the combustion chamber 2, from making contact with the elastic adhesive layer 11 to burn and eventually carbonize it by means of combustion.

### Example No. 2

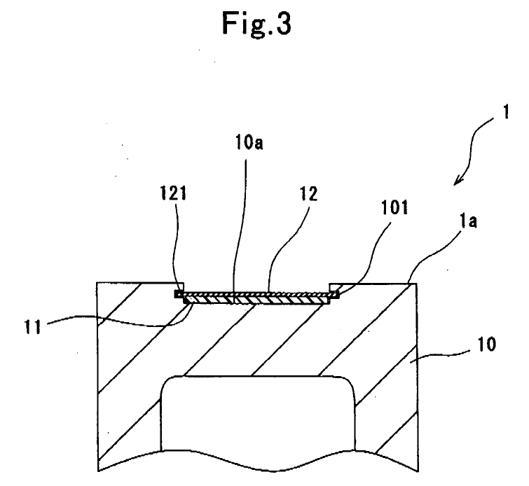

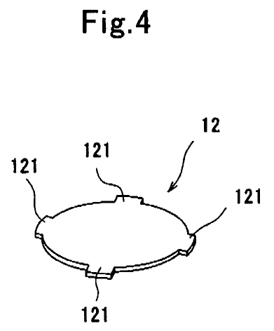

FIGS. 3 and 4 illustrate a piston 1 according to Example No. 2 of the present invention. As shown in the drawings, the present piston 1 according to Example No. 2 comprises protruding engagers 121, and a dented engager 101, which is engageable with the protruding engagers 121, as engaging elements, instead of the annular protrusion 10b which comprises the claimed crimped portion and with which the piston body 10 is provided in the present piston 1 according to Example No. 1. Note that the low thermal-conductivity 12 is provided with the protruding engagers 121. Moreover, the piston body 10's dent 10a is provided with the dented engager 101.

Specifically, the present piston 1 according to Example No. 2 comprises the piston body 10 whose dent 10a is provided with an annular dented engager 101 in the inner peripheral surface. Note that the annular dented engager 101 cannot necessarily be formed as an annular shape as far as it is designed to be engageable with the low thermal-conductivity sheet 12's protruding engagers 121.

Moreover, the present piston 1 according to Example No. 2 comprises the low thermal-conductivity sheet 12, which is provided with four protruding engagers 121. The four protruding engagers 121 protrude from the outer peripheral end of the low thermal-conductivity sheet 12 outwardly in the centrifugal direction thereof, respectively. Note that the four protruding engagers 121 are disposed at equal intervals in the peripheral direction of the low thermal-conductivity sheet 12.

In addition, note the following features herein, that is, in the present piston 1 according to Example No. 2, the configurations and sizes of the piston body 10's dent 10a, elastic adhesive layer 11 and low thermal-conductivity sheet 12 are designed so that only the four protruding engagers 121, of the parts of the low thermal-conductivity sheet 12, make contact with the piston body 10; and so that the low thermal-conductivity sheet 12 covers the elastic adhesive layer 11 completely.

The other constituent elements of the present piston 1 according to Example No. 2 are constructed in the same manner as those of the present piston 1 according to Example No. 1. Therefore, they will not be described hereinafter in detail.

The thus constructed present piston 1 according to Example No. 2 can be manufactured as hereinafter described, for instance.

Specifically, the piston body 10 is molded as a predetermined configuration by means of casting. Then, a liquid monomer, a polyimide precursor, is applied on the entire bottom surface of the piston body 10's dent 10a in a predetermined thickness. Thereafter, the liquid monomer is pre-baked at a temperature of 150° C. or more to evaporate an organic solvent containing therein before placing the low thermal-conductivity sheet 12 thereon. On this occasion, the protruding engagers 121 of the low thermal-conductivity sheet 12 are engaged with the annular dented engager 101 of the piston body 10. Finally, the liquid monomer, a polyimide precursor, is polymerized to cure by heating it to such a high temperature as 200° C. or more, thereby turning it into the elastic adhesive layer 11.

Therefore, in the present piston 1 according to Example No. 2, it is possible to mechanically engage the piston body 10 with the low thermal-conductivity sheet 12 by such a simple method as engaging the low thermal-conductivity sheet 12's protruding engagers 121 with the piston body 10's annular dented engager 101 before bonding the low thermal-conductivity sheet 12 onto the bottom surface of the piston body 10's dent 10a.

Moreover, in the present piston 1 according to Example No. 2, since only the four protruded engages 121, of the parts of the low thermal-conductivity sheet 12, make contact with the piston body 10, it is possible to satisfactorily suppress the heat conduction from the low thermal-conductivity sheet 12 to the piston body 10, for instance, upon starting engine. As a result, the present piston 1 according to Example No. 2 enables the low thermal-conductivity sheet 12 to undergo quick temperature rising.

Except the foregoing advantages, the present piston 1 according to Example No. 2 operates and effects advantages in the same manner as the above-described present piston 1 according to Example No. 1.

### Example No. 3

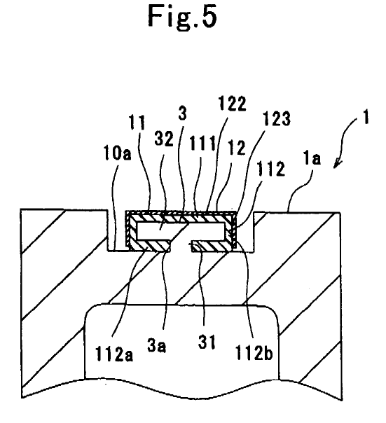

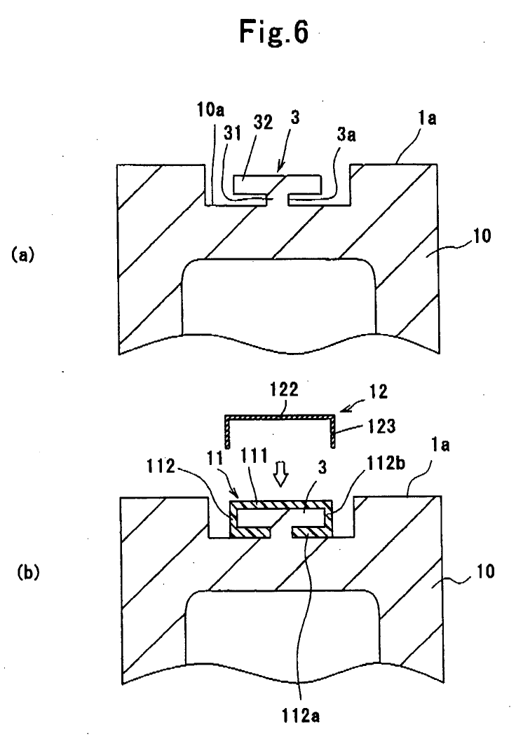

FIGS. 5 and 6 are directed to a piston 1 according to Example No. 3 of the present invention. As can be seen from the drawings, the present piston 1 according to Example No. 3 comprises the piston body 10 whose configuration, especially the configuration of the dent 10a's bottom surface, is formed differently from that of the piston 1 according to Example No. 1; and the elastic adhesive layer 11 and low thermal-conductivity sheet 12 whose configurations are formed differently from their counterparts of the present piston 1 according to Example No. 1.

Specifically, in the present piston 1 according to Example No. 3, the dent 10a of the piston body 10 is provided with a protrusion 3 on the bottom surface as illustrated in FIGS. 5 and 6. As shown in the drawings, the protrusion 3 is formed as a letter “T” shape in cross section, and comprises a pillar-shaped neck 31, and a disk-shaped head 32. The pillar-shaped neck 31 is disposed upright on the bottom surface of the dent 10a integrally therewith. The disk-shaped head 32 is disposed consecutively to the leading end (or top end) of the pillar-shaped neck 31. Note that the outside diameter of the pillar-shaped neck 31 is set smaller than the outside diameter of the disk-shaped head 32. Thus, an outer peripheral surface of the protrusion 3 provides an annular dented engager 3a.

Moreover, in the present piston 1 according to Example No. 3, the elastic adhesive layer 11 comprises a leading-end surface 111, and a peripheral surface 112 as expressly designated in FIGS. 5 and 6 (b). The leading-end surface 111 is formed on the protrusion 3's top surface (or the disk-shaped head 32's top surface specifically). The peripheral surface 112 is formed on the protrusion 3's outer peripheral surface, which involves the annular dented engager 3a, (or the pillar-shaped neck 31's outer peripheral surface as well as the disk-shaped head 32's outer peripheral surface specifically). Moreover, as designated explicitly in FIGS. 5 and 6(b), the peripheral surface 112 comprises a first peripheral-surface section 112a, and a second peripheral-surface section 112b. The first peripheral-surface section 112a is formed on the pillar-shaped neck 31's outer peripheral surface, that is, within the protrusion 3's dented engager 3a. The second peripheral-surface section 112b is formed on the disk-shaped head 32's outer peripheral surface. Note herein that the peripheral surface 112's first peripheral section 112a makes an annular protruded engager, which engages with the protrusion 3's annular dented engager 3a. Thus, the elastic adhesive layer 11 is formed on the outer surface of the protrusion 3 entirely, that is, the elastic adhesive layer 11 surrounds the entire protrusion 3.

In addition, in the present piston 1 according to Example No. 3, the low thermal-conductivity sheet 12 is formed as a bottomed cylindrical shape. To put it differently, the low thermal-conductivity sheet 12 comprises a leading-end-surface covering portion 122, and a peripheral-surface covering portion 123 as expressly designated in FIGS. 5 and 6 (a). Specifically, as explicitly shown in FIG. 6 (b), the leading-end-surface covering portion 122 is formed so as to cover the elastic adhesive layer 11's leading-end surface 111. The peripheral-surface covering portion 123 is formed so as to cover the elastic adhesive layer 11's peripheral surface 112. Note that, as illustrated in FIG. 5, the low thermal-conductivity sheet 12's peripheral-surface covering portion 123 covers, of the elastic adhesive layer's peripheral surface 112, the peripheral-surface section 112a mostly, and the second peripheral-surface section 112b entirely. In other words, the low thermal-conductivity sheet 12's peripheral-surface covering portion 123 does not cover the elastic adhesive layer 1's peripheral surface 112 entirely, thereby providing a space between the leading end of the low thermal-conductivity sheet 12's peripheral-surface covering portion 123 (or the opening end of the bottomed cylindrical shape specifically) and the bottom surface of the piston body 10's dent 10a as shown in FIG. 5. Therefore, the low thermal-conductivity sheet 12 and the piston body 10 are separated away from each other, and do not make contact with each other at all.

The other constituent elements of the present piston 1 according to Example No. 3 are constructed in the same manner as those of the present piston 1 according to Example No. 1. Therefore, they will not be described hereinafter in detail.

The thus constructed present piston 1 according to Example No. 3 can be manufactured as hereinafter described, for instance.

Specifically, the piston body 10 is molded as a predetermined configuration by means of casting. Then, a liquid monomer, a polyimide precursor, is applied on predetermined locations in the bottom surface of the piston body 10's dent 10a as well as on the entire outer surface of the protrusion 3 in a predetermined thickness. Thereafter, the liquid monomer is pre-baked at a temperature of 150° C. or more to evaporate an organic solvent containing therein before covering it with the low thermal-conductivity sheet 12 having the above-described bottomed cylindrical configuration. Finally, the liquid monomer, a polyimide precursor, is polymerized to cure by heating it to such a high temperature as 200° C. or more, thereby turning it into the elastic adhesive layer 11.

In the present piston 1 according to Example No. 3, the first peripheral-surface section 112a (i.e., claimed protruded engager) of the elastic adhesive layer 11's peripheral surface 112 is formed within the dented engager 3a of the protrusion 3 that protrudes from the dent 10a of the piston body 10. Accordingly, the dented engager 3a of the protrusion 3 engages with the first peripheral-surface section 112a (i.e., claimed protruded engager) of the elastic adhesive layer 11's peripheral surface 112 mechanically. Consequently, it is possible to reliably inhibit the elastic adhesive layer 11 from coming off from the piston body 10.

Moreover, in the present piston 1 according to Example No. 3, not only the leading-end-surface covering portion 122 of the low thermal-conductivity sheet 12 covers the leading-end surface 111 of the elastic adhesive layer 11 completely, but also the peripheral-surface covering portion 123 of the low thermal-conductivity sheet 12 covers the peripheral surface 112 of the elastic adhesive layer 11 almost entirely. Accordingly, the low thermal-conductivity sheet 12 can reliably inhibit the elastic adhesive layer 11 from being exposed to the combustion chamber 2. Consequently, the low thermal-conductivity sheet 12 makes it possible to satisfactorily keep the combustion chamber 2's heat from degrading the elastic adhesive layer 11, or to satisfactorily keep fires, which combust within the combustion chamber 2, from burning the elastic adhesive layer 11 to eventually carbonize it.

In addition, in the present piston 1 according to Example No. 3, since the low thermal-conductivity sheet 12 is kept away from the piston body 10 so that it does not make contact with the piston body 10, no heat conduction occurs from the low thermal-conductivity sheet 12 to the piston body 10, for instance, upon starting engine. As a result, the present piston 1 according to Example No. 3 makes it possible to increase the temperature of the low thermal-conductivity sheet 12 quickly.

Except the foregoing advantages, the present piston 1 according to Example No. 3 operates and effects advantages in the same manner as the above-described present piston 1 according to Example No. 1.

### Example No. 4

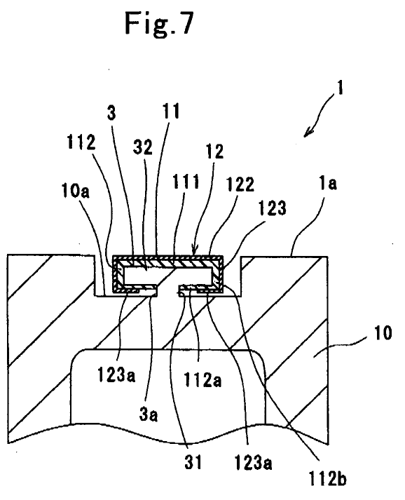

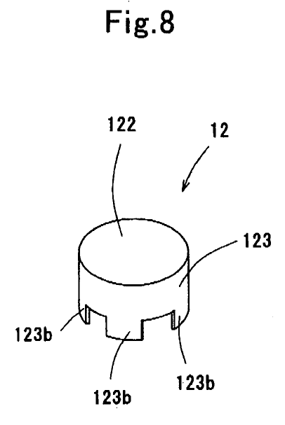

FIGS. 7 and 8 illustrate a piston 1 according to Example No. 4 of the present invention. The present piston 1 according to Example No. 4 comprises the elastic adhesive layer 11 and low thermal-conductivity sheet 12 whose configurations are changed from those of the present piston 1 according to Example No. 3.

Specifically, in the present piston 1 according to Example No. 4, the first peripheral-surface section 112a (i.e., claimed protruded engager) of the elastic adhesive layer 11's peripheral surface 112 is formed on a part of the outer peripheral surface of the protrusion 3's pillar-shaped neck 31, that is, on a part inside the dented engager 3a of the protrusion 3. More specifically, as shown in FIG. 7, the first peripheral-surface section 112a (i.e., claimed protruded engager) of the elastic adhesive layer 11's peripheral surface 112 is formed, of the pillar-shaped neck 31's outer peripheral surface, only on an outer peripheral surface that adjoins the disk-shaped head 32. As a result, the first peripheral-surface section 112a (i.e., claimed protruded engager) of the elastic adhesive layer 11's peripheral surface 112 is not formed, of parts inside the dented engager 3a of the protrusion 3, on a part that adjoins the bottom surface of the piston body 10's dent 10a, thereby providing a space between the first peripheral-surface section 112a (i.e., claimed protruded engager) of the elastic adhesive layer 11 and the bottom surface of the dent 10a as shown in FIG. 7.

Moreover, in the present piston 1 according to Example No. 4, the low thermal-conductivity sheet 12 comprises four bent engagers 123a. As can be understood from FIG. 8, the bent engagers 123a are made by bending the low thermal-conductivity sheet 12's peripheral-surface covering portion 123 inwardly at around the leading end (or the opening end of the bottomed cylindrical configuration specifically), thereby engaging with the protrusion 3's dented engager 3a as illustrated in FIG. 7. Note herein that the bent engagers 123a engage with the dented engager 3a of the piston body 10's protrusion 3 by way of the elastic adhesive layer 11's first peripheral-surface section 112a (i.e., claimed protruded engager) that is interposed therebetween. As shown in FIG. 8, the four bent engagers 123a are placed at equal intervals in the peripheral direction of the low thermal-conductivity sheet 12. Note that, although the peripheral-surface covering portion 123 of the low thermal-conductivity sheet 12 covers the outermost peripheral surface of the elastic adhesive layer 11's peripheral surface 112 entirely as shown in FIG. 7, only the four bent engagers 123 of the low thermal-conductivity sheet 12 partially cover the lower surface of the elastic adhesive layer 11's first peripheral-surface section 112a, that is, claimed protruded engager, (or, of surfaces of the first peripheral-surface section 112a, a surface that faces the bottom surface of the piston body 10's dent 10a specifically) as shown in the drawing. In addition, a space is provided not only between the leading end of the low thermal-conductivity sheet 12's peripheral-surface covering portion 123 (or the opening end of the bottomed cylindrical configuration specifically) and the bottom surface of the dent 10a, but also between the bent engagers 123a of the low thermal-conductivity sheet 12 and the bottom surface of the dent 10a. Thus, the low thermal-conductivity sheet 12 does not make contact with the piston body 10 at all.

The other constituent elements of the present piston 1 according to Example No. 4 are constructed in the same manner as those of the present piston 1 according to Example No. 3. Therefore, they will not be described hereinafter in detail.

The thus constructed present piston 1 according to Example No. 4 can be manufactured as hereinafter described, for instance.

Specifically, the piston body 10 is molded as a predetermined configuration by means of casting. Then, a liquid monomer, a polyimide precursor, is applied on predetermined locations of the protrusion 3, which is disposed within the dent 10a, in a predetermined thickness. Thereafter, the liquid monomer is pre-baked at a temperature of 150° C. or more to evaporate an organic solvent containing therein. Then, the low thermal-conductivity sheet 12 is put on the protrusion 3. Note herein that, in the present piston 1 according to Example No. 4, the low thermal-conductivity sheet 12 is formed as the above-described configuration that is provided with four tabs 123b, which are disposed to extend linearly from the leading end of the low thermal-conductivity sheet 12's peripheral-surface covering portion 122 (or the opening end of the bottomed cylindrical configuration specifically) as illustrated in FIG. 8, and which turn into the four bent engagers 123a by a bending process by means of crimping. Thereafter, the liquid monomer, a polyimide precursor, is polymerized to cure by heating it to such a high temperature as 200° C. or more, thereby turning it into the elastic adhesive layer 11. Finally, the four tabs 123b of the low thermal-conductivity sheet 12 are bent inwardly by a bending process by means of crimping to turn them into the bent engagers 123a comprising the claimed crimped portion, thereby engaging the bent engagers 123a of the low thermal-conductivity sheet 12 with the dented engager 3a of the protrusion 3.

In the present piston 1 according to Example No. 4, since the four bent engagers 123a of the low thermal-conductivity sheet 12 engage with the dented engager 3a of the piston body 10′ protrusion 3 mechanically, the resulting mechanical engaging force makes it possible to satisfactorily keep the low thermal-conductivity sheet 12 from coming off from the piston body 10.

Moreover, in the present piston 1 according to Example No. 4, it is possible to mechanically engage the piston body 10 with the low thermal-conductivity sheet 12 by such a simple method as bending the parts of the low thermal-conductivity sheet 12 (or the tabs 123b specifically), which turn into the bent engagers 123a of the low thermal-conductivity sheet 12, inwardly by means of crimping and then engaging the resultant bent engagers 123a with the dented engager 3a of the piston body 10's protrusion 3 after bonding the low thermal-conductivity sheet 12 on the protrusion 3 in the piston body 10's dent 10a.

Except the foregoing advantages, the present piston 1 according to Example No. 4 operates and effects advantages in the same manner as the above-described present piston 1 according to Example No. 3.

### Example No. 5

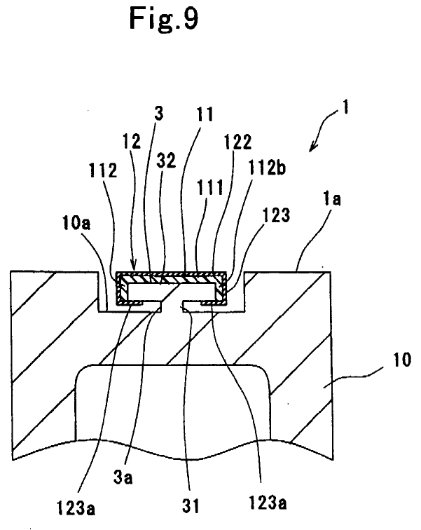

FIG. 9 is directed to a piston 1 according to Example No. 5 of the present invention. As shown in the drawing, the present piston 1 according to Example No. 5 comprises the elastic adhesive layer 11 and low thermal-conductivity sheet 12, which are similar to those of the present piston 1 according to Example No. 4 but whose configurations are changed.

Specifically, in the present piston 1 according to Example No. 5, the outer peripheral surface of the protrusion 3's pillar-shaped neck 31 (or the inner side of the protrusion 3's dented engager 3a specifically) is not covered with the elastic adhesive layer 11. More specifically, the elastic adhesive layer 11's peripheral surface 112 comprises the second peripheral-surface section 112b alone that covers the outer peripheral surface of the protrusion 3's disk-shaped head 32.

Moreover, in the present piston 1 according to Example No. 5, the low thermal-conductivity sheet 12's four bent engagers 123a contact with the lower surface of the protrusion 3's disk-shaped head 32 (or a surface that faces the bottom surface of the piston body 10's dent 10a specifically). In other words, the low thermal-conductivity sheet 12's four bent engagers 123a engage directly with the dented engager 3a of the piston body 10's protrusion 3 without interposing the elastic adhesive layer 11 therebetween.

The other constituent elements of the present piston 1 according to Example No. 5 are constructed in the same manner as those of the present piston 1 according to Example No. 4. Therefore, they will not be described hereinafter in detail.

Therefore, in the present piston 1 according to Example No. 5, since, of the parts of the low thermal-conductivity sheet 12, only the four bent engagers 123a make contact with the piston body 10's protrusion 3, the present piston 1 according to Example No. 5 can satisfactorily suppress the heat conduction from the low thermal-conductivity sheet 12 to the piston body 10, for instance, upon starting engine. As a result, the present piston 1 according to Example No. 5 enables the low thermal-conductivity sheet 12 to undergo quick temperature increment.

Note that, in the present piston 1 according to Example No. 5, heat conduction occurs from the low thermal-conductivity sheet 12 to the piston body 10 by way of the contact between them, because the four bent engagers 123a of the low thermal-conductivity sheet 12 make contact with the protrusion 3 of the piston body 10.

Except the foregoing advantages, the present piston 1 according to Example No. 5 operates and effects advantages in the same manner as the above-described present piston 1 according to Example No. 4.

### Example No. 6

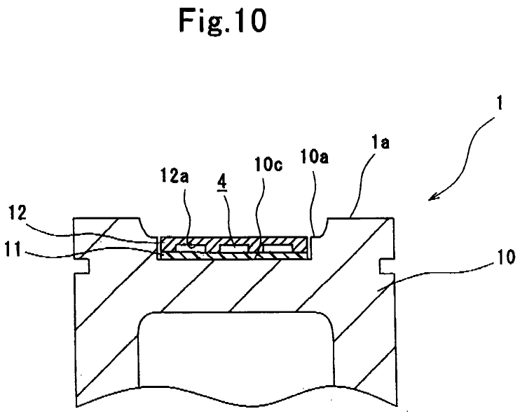

FIG. 10 illustrates a piston 1 according to Example No. 6 of the present invention. As shown in the drawing, the present piston 1 according to Example No. 6 comprises the piston body 10 whose dent 10a is formed as a different configuration from that of the present piston 1 according to Example No. 1, and the low thermal-conductivity sheet 12 which is formed as a different configuration from that of the present piston 1 according to Example No. 1.

Specifically, in the present piston 1 according to Example 6, the bottom surface of the piston body 10's dent 10a is provided with an indented step 10c. The indented step 10c exhibits a bottom-surface configuration, which corresponds to the low thermal-conductivity sheet 12's outer configuration. Moreover, the elastic adhesive layer 11 bonds the low thermal-conductivity sheet 12 onto the dented step 10c's bottom surface.

In addition, the low thermal-conductivity sheet 12's lower surface is provided with a plurality of cavities 12a for making hollows. Thus, the cavities 12a form hollows 4 between the low thermal-conductivity sheet 12 and the elastic adhesive layer 11.

The other constituent elements of the present piston 1 according to Example No. 6 are constructed in the same manner as those of the present piston 1 according to Example No. 1. Therefore, they will not be described hereinafter in detail.

Note that, in the present piston 1 according to Example No. 6, the hollows 4, which are formed between the low thermal-conductivity sheet 12 and the elastic adhesive layer 11, function as an air heat-insulation layer, respectively. Accordingly, it is possible to more quickly increase the temperature of the low thermal-conductivity sheet 12 when starting engine or running it at low load. Consequently, the present piston 1 according to Example No. 6 can prevent the generation of unburned gases more effectively.

Moreover, the present piston 1 according to the present Example No. 6 exhibits a decreased contact area between the low thermal-conductivity sheet 12 and the elastic adhesive layer 11, contact area which is smaller by the sum of the hollow 4's perpendicularly-projected cross-sectional areas than that the present piston 1 according to Example No. 1 exhibits. As a result, the present piston 1 according to Example No. 6 can promote the advantage, increasing the temperature of the low thermal-conductivity sheet 12 more quickly, thereby making it possible to more effectively prevent the occurrence of unburned gases.

Except the foregoing advantages, the present piston 1 according to Example No. 6 operates and effects advantages in the same manner as the above-described present piston 1 according to Example No. 1.

### Example No. 7

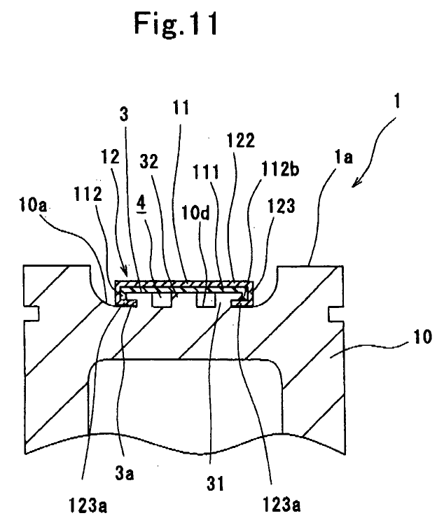

FIG. 11 is directed to a piston 1 according to Example No. 7 of the present invention. As shown in the drawing, the present piston 1 according to Example No. 7 comprises the piston body 10 whose protrusion 3 is changed from that of the present piston 1 according to Example No. 5.

Specifically, in the present piston 1 according to Example 7, the top surface of the piston body 10's protrusion 3 is provided with a plurality of cavities 10d for making hollows. Thus, the cavities 10d form hollows 4 between the piston body 10 and the elastic adhesive layer 11.

The other constituent elements of the present piston 1 according to Example No. 7 are constructed in the same manner as those of the present piston 1 according to Example No. 5. Therefore, they will not be described hereinafter in detail.

Similarly to the present piston 1 according to Example No. 6, in the present piston 1 according to Example No. 7 as well, the hollows 4, which are formed between the piston body 10 and the elastic adhesive layer 11, function as an air heat-insulation layer, respectively. Accordingly, the hollows 4 enable the low thermal-conductivity sheet 12 to undergo temperature increment more quickly when starting engine or running it at low load. Consequently, the hollows 4 enable the present piston 1 according to Example No. 7 to prevent the generation of unburned gases more effectively.

Moreover, the present piston 1 according to the present Example No. 7, compared with the present piston 1 according to Example No. 5, exhibits a contact area between the piston body 10 and the elastic adhesive layer 11, contact area which is decreased by the sum of the hollow 4's cross-sectional areas that are projected perpendicularly upward. As a result, the present piston 1 according to Example No. 7 can produce the advantage, enabling the low thermal-conductivity sheet 12 to undergo more quick temperature increment, in a facilitated manner, and can thereby prevent unburned gases from generating more effectively.

Except the foregoing advantages, the present piston 1 according to Example No. 7 operates and effects advantages in the same manner as the above-described present piston 1 according to Example No. 1.

### Modified Versions of Example Nos. 1 through 7

In the above-described pistons 1 according to Example Nos. 1 through 7, it is possible as well to mix foams or minute glassy substances in the elastic adhesive layer 11. This enables the elastic adhesive layer 11 to produce more enhanced heat insulation effect. Therefore, such an elastic adhesive layer 11 makes it possible to increase the temperature of the low thermal-conductivity sheet 12 more quickly, for instance, upon starting engine.

Having now fully described the present invention, it will be apparent to one of ordinary skill in the art that many changes and modifications can be made thereto without departing from the spirit or scope of the present invention as set forth herein including the appended claims.

What is claimed is:

1. A piston comprising:
a piston body having a piston top surface facing a combustion chamber, and exhibiting a first thermal conductivity;
an elastic adhesive layer being formed on the piston top surface of the piston body, and comprising a heat resistant resin; and
a low thermal-conductivity sheet being formed on the elastic adhesive layer, and exhibiting a second thermal conductivity being lower than the first thermal conductivity of the piston body and falling in a range of from 5 or more to 40 W/m·K or less.

2. The piston according to claim 1, wherein:
the piston body has a dent being disposed in the piston top surface and having a bottom surface, and a protrusion being disposed on the bottom surface of the dent and having a leading-end surface;
the protrusion has an outer peripheral surface, and a dented engager being disposed in the outer peripheral surface;
the elastic adhesive layer has a leading-end surface being formed on the leading-end surface of the protrusion, and a peripheral surface being formed on the outer peripheral surface of the protrusion; and
the low thermal-conductivity sheet is formed as a bottomed cylindrical configuration, the bottomed cylindrical configuration having a leading-end-surface covering portion for covering the leading-end surface of the elastic adhesive layer and a peripheral-surface covering portion for covering the peripheral surface of the elastic adhesive layer.

3. The piston according to claim 2, wherein the elastic adhesive layer includes a protruded engager, which engages with the dented engager of the protrusion of the piston body.

4. The piston according to claim 2, wherein the low thermal-conductivity sheet further has a bent engager, being made by bending the peripheral-surface covering portion inwardly at around a free end thereof, and engaging with the dented engager of the protrusion.

5. The piston according to claim 2, wherein the elastic adhesive layer intervenes between the piston body and the low thermal-conductivity sheet to separate the piston body and the low thermal-conductivity sheet away from each other.

6. The piston according to claim 1, wherein:
the piston body further has a dent being disposed in the piston top surface, and being provided with a bottom surface and an inner peripheral surface;
the elastic adhesive layer is formed on the bottom surface of the dent of the piston body; and
one of the piston body and the low thermal-conductivity sheet has an engager engaging with another one of the piston body and the low thermal-conductivity sheet.

7. The piston according to claim 6, wherein the engager comprises a crimped portion being formed by means of crimping process.

8. The piston according to claim 6, wherein:
the piston body has a dented engager being disposed in the inner peripheral surface of the dent; and
the low thermal-conductivity sheet has an outer peripheral end, and a protruding engager protruding outward from the outer peripheral end and engaging with the dented engager.

9. The piston according to claim 1, wherein the piston body or the low thermal-conductivity sheet has a cavity for making a hollow between the piston body or the low thermal-conductivity sheet and the elastic adhesive layer.

10. The piston according to claim 1, wherein the low thermal-conductivity sheet comprises at least one member being selected from the group consisting of titanium, titanium alloys and stainless steels.

11. The piston according to claim 1, wherein the elastic adhesive layer exhibits a third thermal conductivity, which is lower than the second thermal conductivity of the low thermal-conductivity sheet.

12. The piston according to claim 11, wherein the elastic adhesive layer comprises at least one member being selected from the group consisting of polyimide, denatured polyimide, polybenzimidazole and denatured polybenzimidazole.

13. The piston according to claim 1, wherein the low thermal-conductivity sheet exhibits a thickness of from 0.1 to 0.5 mm.

14. The piston according to claim 1, wherein the elastic adhesive sheet exhibits a thickness of from 0.01 to 1.0 mm.

15. A process for manufacturing piston, the piston comprising: a piston body having a piston top surface facing a combustion chamber, and exhibiting a first thermal conductivity; an elastic adhesive layer being formed on the piston top surface of the piston body, and comprising a heat resistant resin; and a low thermal-conductivity sheet being formed on the elastic adhesive layer, and exhibiting a second thermal conductivity being lower than the first thermal conductivity of the piston body and falling in a range of from 5 or more to 40 W/m K or less;
the piston manufacturing process comprising the steps of:
applying an elastic adhesive agent containing an organic solvent onto the piston body;
prebaking the elastic adhesive agent by heating the elastic adhesive agent to a predetermined temperature, thereby evaporating the organic solvent;
disposing the low thermal-conductivity sheet onto the prebaked elastic adhesive agent; and
bonding the piston body with the low thermal-conductivity sheet by further heating the prebaked elastic adhesive agent to polymerize and cure it, thereby turning the prebaked elastic adhesive agent into the elastic adhesive layer, which bonds the piston body with the low thermal-conductivity sheet.
